(19) United States
(12) Patent Application Publication
(10) Pub. No.: US 2008/0143283 A1
(43) Pub. Date: Jun. 19, 2008

(54) SYSTEM, METHOD, AND COMPUTER SOFTWARE CODE FOR CONTROLLING PERFORMANCE OF A DYNAMIC BRAKING SYSTEM

(76) Inventors: Mark Nicolussi, Erie, PA (US); Carl S. Iszkula, Girard, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/958,782

(22) Filed: Dec. 18, 2007

Related U.S. Application Data
(60) Provisional application No. 60/870,452, filed on Dec. 18, 2006.

(51) Int. Cl. H02P 3/06

(52) U.S. Cl. 318/375

(57) ABSTRACT

A method for controlling a performance of a dynamic braking system to maintain a dynamic braking tractive effort current plateau and/or improve the dynamic braking tractive effort current plateau, the method including sensing the traction motor field current and regulating the traction motor field current to maintain at least one of a constant armature current, a constant braking effort, and a constant field current based on the traction motor field current sensed. A system and a computer software code are also disclosed for controlling a performance of the dynamic braking system to maintain the dynamic braking tractive effort current plateau and/or improve the dynamic braking tractive effort current plateau.

### CROSS-REFERENCE TO RELATED APPLICATIONS

This application claims priority based on U.S. Provisional Application No. 60/870,452 filed Dec. 18, 2006, which is incorporated herein by reference.

### BACKGROUND OF THE INVENTION

This invention relates to a braking system and, more specifically, to a system, method, and computer software code for controlling a dynamic braking system performance.

Diesel electric locomotives and off-highway vehicles generally have two approaches for slowing. With respect to diesel electric locomotives, they are usually a part of a train, where a train includes at least one locomotive and one rail car. A first approach for slowing is to apply air brakes that when engaged apply brake shoes to the wheels of the locomotive and/or rail cars. Applying the air brakes converts the kinetic energy of the train's motion into heat in the wheels, brake shoes, and rails.

A second approach is referred to as “dynamic braking” (or DB). In dynamic braking, the electric transmission system that normally powers each axle of the locomotive is used to slow the train by applying a force to the rail in a direction that produces deceleration of the train. This is accomplished by electrically reconfiguring the drive motors on each axle (traction motors) as generators. This allows the kinetic energy in the train to be converted to electrical power, which is then dissipated to the atmosphere using a series of resistive heating elements and cooling fans. The train is slowed because the energy dissipated is resulting in a reduction in the kinetic energy of motion, and thus slowing of speed of the locomotive and the rail cars.

Dynamic braking is used for moderate slowing, in place of the rail car air brakes. Dynamic braking is also used for maximum braking when used in conjunction with the rail car air brakes. Although dynamic braking functions similar to shoe brakes in converting electric energy into heat, there is little required maintenance with a dynamic braking system other than periodic replacement of the brushes in the DC fan motors. Dynamic braking thus provides cost savings to an operator in contrast with shoe brakes, which inevitably wear and require adjustment and replacement with use over time.

The main controlling feature of dynamic braking is to either limit the traction motor field current (I_{f}) control or limit the armature current (Iₐ) control. At lower speeds, when the system is typically regulating on constant field current, the generated braking effort falls off quickly as speed decreases.

Modem electric traction systems for locomotives and off-highway vehicles use either an AC-DC (engine driven alternator produces AC power, which is rectified to drive DC traction motors) or AC-DC-AC (engine driven alternator produces AC power, which is rectified and then converted to AC power of variable frequency).

FIG. 1 depicts a portion of a prior art AC-DC traction system circuit in its normal ‘motoring’ configuration. In the motoring configuration the locomotive is generating force to pull the train forward. The locomotive utilizes series-wound DC traction motors 10, where the armature 12 and field coils 14 experience the same electrical current.

FIG. 2 depicts the same portion of the circuit reconfigured for DB. In this case, the field coils 14 are separated from the armatures 12. The field coils receive their power directly from the rectifier 16, i.e., they are separately excited. The current in the field coils will be referred to as I_{f}. The armatures 12 generate their own current due to their rotation, power by the forward momentum of the train. The armature current (Iₐ) generated is a function of the field current and the resistance 8 connected across the armatures 12. More specifically, only I_{f} can be actively controlled by varying the input to the traction rectifier. Iₐ is only indirectly controlled by varying I_{f}. Prior art imposes a fixed limit on both I_{f} and on Iₐ, and imposes the more limiting of the two at a given speed.

FIG. 3 depicts a graph illustrating how the locomotives retarding force varies with I_{f} and Iₐ. Because operating principles are the same when operating at lower performance levels, all discussions center on maximum performance levels. Current practice is to maintain I_{f} at a constant value at low speeds. As speed increases, Iₐ and the resulting force increase proportionately. At some point, Iₐ reaches a limit, and at speeds beyond this point, I_{f} is varied to maintain a constant Iₐ, and the resulting force drops approximately as a function of 1/speed. Current practice it to regulate on either a constant I_{f} or a constant Iₐ to produce an available operating range 15.

If the vehicle is operating at speed A, as the controller is moved from 0 to 100% application, I_{f} will be actively increased, and as a result, Iₐ and the developed effort will increase until Iₐ reaches its limit. As speed decreases, I_{f} will increased in order to maintain a constant Iₐ. At the peak, both Iₐ and I_{f} are at their limit. Below this speed, I_{f} will be more limiting than Iₐ, and I_{f} will not increase any further.

The maximum force generated is typically limited to a fixed percentage of the vehicle weight, to ensure that adequate friction (adhesion) is available to decelerate the train. This can lead to situations where I_{f} is limited to relatively low levels in order to keep the peak force within acceptable bounds. Given the specifics of the hardware involved in the system illustrated in FIG. 3, it may be possible to increase the maximum I_{f} to a higher limit, but this would then increase the peak force generated unless Iₐ were reduced, which would then reduce performance at higher speeds.

A variation on the standard DB circuit is illustrated in FIG. 4. This is normally called ‘extended range’ braking. In this case the resistance is varied by shunting contactors 20, and in so doing, improved low speed performance is obtained, such as is illustrated in FIG. 5. [symbol] The basic approach of maintaining a constant I_{f} and Iₐ is maintained from the simple system described above, and the resulting performance is effectively several of the performance curves illustrated in FIG. 3, superimposed upon each other.

This system illustrated in FIG. 4 is utilized when various constraints, such as but not limited to available physical space, weight, cost, etc., justify the added complexity. When compared to the normal DB braking system, the extended range braking system requires additional packaging space due to added complexity and additional hardware. Depending on the make and/or model of the locomotive motive or off-highway vehicle, additional packaging space is not available it retrofitting a system to use the extended range braking system is desired.

Manufacturers and operators of locomotives and off highway vehicles would benefit from a system and method which would allow for less expensive extended dynamic braking as well as allowing for extended dynamic braking in locomotives and/or off highway vehicles that do not have the physical space to accommodate the additional equipment required for this type of dynamic braking system.

### BRIEF DESCRIPTION OF THE INVENTION

Embodiments of the invention disclose a system, method, and computer software code for controlling a performance of a dynamic braking system to maintain a dynamic braking tractive effort current plateau and/or improve the dynamic braking tractive effort current plateau. The method includes sensing the traction motor field current. The method further discloses regulating the traction motor field current to maintain a constant armature current, a constant braking effort, and/or a constant field current based on the traction motor field current sensed.

The system includes at least one sensor to measure armature current and/or a traction motor field current. A processor is further provided and is configured to receive a measurement from the at least one sensor and to determine a braking control. A controller is also provided and is configured to regulate a traction motor field current control, limit an armature current control, and/or limit the dynamic braking tractive effort based on the braking control from the processor.

The computer software code is storable on a computer media and operable in a processor. The computer software code includes a computer software module for gathering a measurement from a traction motor field current. A computer software module is also provided for regulating the traction motor field current to maintain at least one of a constant armature current, a constant braking effort, and a constant field current based on the traction motor field current sensed.

Another method is disclosed for measuring an armature current and/or a traction motor field current. The method further discloses regulating the traction motor field current to maintain a constant armature current, regulating the traction motor field current to maintain a constant braking effort, and maintaining a constant field current. The method further discloses alternating between regulating the traction motor field current to maintain the constant armature current, regulating the traction motor field current to maintain the constant braking effort, and/or maintain the constant field current when a decrease in armature current is detected.

### BRIEF DESCRIPTION OF THE DRAWINGS

A more particular description of exemplary embodiments of the invention briefly described above will be rendered by reference to specific embodiments thereof that are illustrated in the appended drawings. Understanding that these drawings depict only typical embodiments of the invention and are not therefore to be considered to be limiting of its scope, the exemplary embodiments of the invention will be described and explained with additional specificity and detail through the use of the accompanying drawings in which:

FIG. 1 depicts a portion of a prior art AC-DC traction system circuit in its normal ‘motoring’ configuration;

FIG. 2 depicts a prior art standard dynamic braking system;

FIG. 3 depicts a prior art performance characteristic curve for a standard dynamic braking system;

FIG. 4 depicts a prior art extended range dynamic braking system;

FIG. 5 depicts a prior art performance characteristic curve of an extended range dynamic braking system;

FIG. 6 depicts an exemplary embodiment of an improved dynamic braking system performance curve compared to the prior art performance curve;

FIG. 7 depicts an exemplary embodiment of an improved extended range dynamic braking system (with four resistance values) performance curve compared to the prior art performance curve;

FIG. 8 depicts an exemplary embodiment of an improved extended range dynamic braking system (with two resistance values) performance curve compared to the prior art performance curve;

FIG. 9 depicts an exemplary flow chart for controlling a performance of a dynamic braking system to maintain a dynamic braking tractive effort current plateau and/or improve the dynamic braking tractive effort current plateau;

FIG. 10 depicts an exemplary flow chart for controlling a performance of a dynamic braking system to maintain a dynamic braking tractive effort current plateau and/or improve the dynamic braking tractive effort current plateau;

FIG. 11 depicts an exemplary illustration of elements for controlling a performance of a dynamic braking system to maintain a dynamic braking tractive effort current plateau and/or improve the dynamic braking tractive effort current plateau; and

FIG. 12 depicts another exemplary illustration of elements for controlling a performance of a dynamic braking system to maintain a dynamic braking tractive effort current plateau and/or improve the dynamic braking tractive effort current plateau.

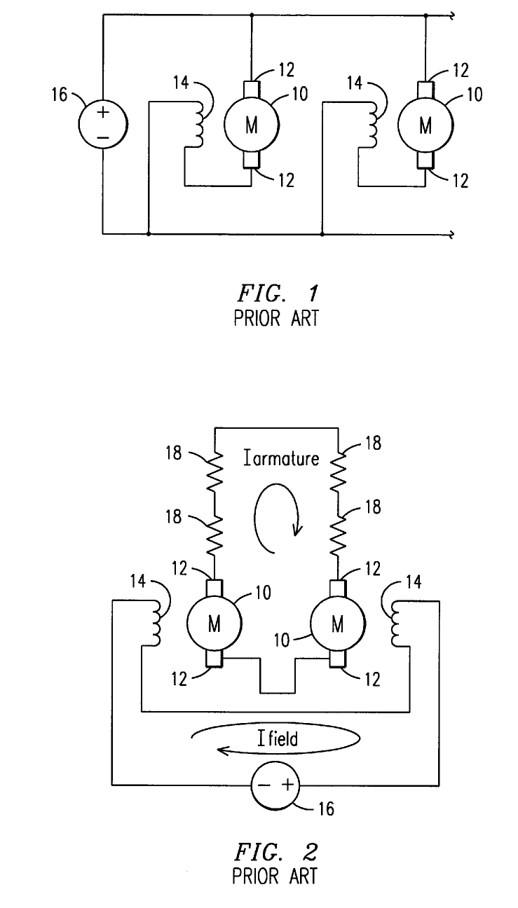

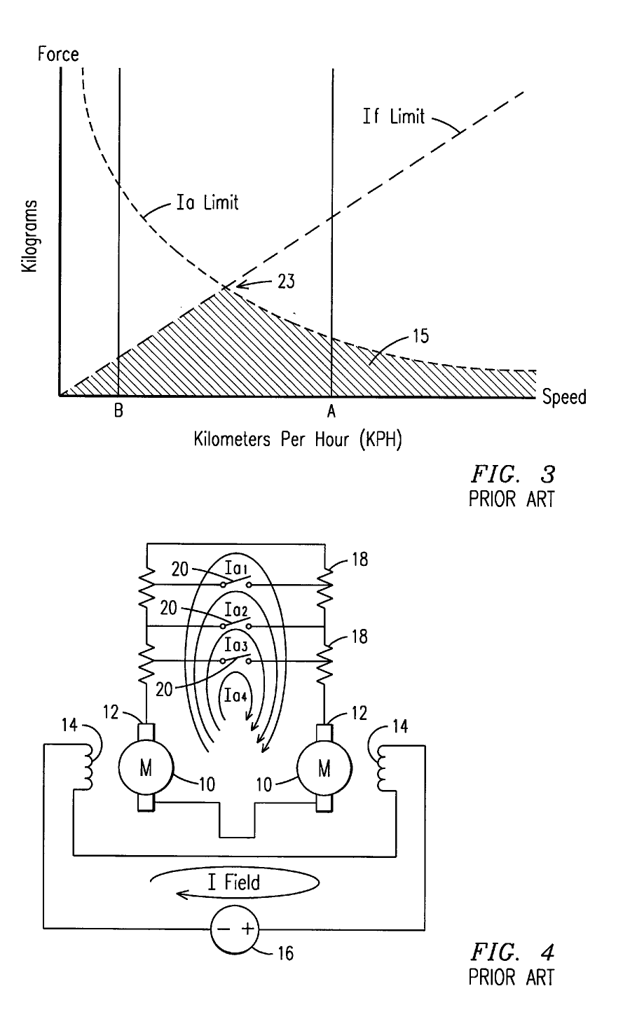

### DETAILED DESCRIPTION OF THE INVENTION

Exemplary embodiments of the present invention solves the problems in the art by providing a system, method, and computer software code, for improving operating capabilities of a dynamic braking system. Persons skilled in the art will recognize that an apparatus, such as a data processing system, including a CPU, memory, I/O, program storage, a connecting bus, and other appropriate components, could be programmed or otherwise designed to facilitate the practice of the method of an exemplary embodiment of the invention. Such a system would include appropriate program means for executing the method.

Broadly speaking, the technical effect controlling a performance of a dynamic braking system to maintain a dynamic braking tractive effort current plateau and/or improve the dynamic braking tractive effort current plateau. Embodiments of the invention may be described in the general context of computer-executable instructions, such as program modules, being executed by any device, such as but not limited to a computer, designed to accept data and/or perform prescribed mathematical and/or logical operations usually at high speed, where results of such operations may or may not be displayed. Generally, program modules may include routines, programs, objects, components, data structures, etc., that perform particular tasks or implement particular abstract data types. For example, the software programs that underlie the embodiments can be coded in different programming languages, for use with different computing platforms. It will be appreciated, however, that the principles that underlie the embodiments can be implemented with other types of computer software technologies as well.

Moreover, those skilled in the art will appreciate that embodiments may be practiced with other computer system configurations, multiprocessor systems, minicomputers, and the like. Embodiments may also be practiced in distributed computing environments where tasks are performed by remote processing devices that are linked through a communications network. In a distributed computing environment, program modules may be located in both local and remote computer storage media including memory storage devices.

Also, an article of manufacture, such as a pre-recorded disk or other similar computer program product, for use with a data processing system, could include a storage medium and program means recorded thereon for directing the data processing system to facilitate the practice of the embodiment of the invention. Such apparatus and articles of manufacture also fall within the spirit and scope of embodiments disclosed.

Referring now to the drawings, embodiments of the present invention will be described. The invention can be implemented in numerous ways, including as a system (including a computer processing system), a method (including a computer implemented method), an apparatus, a computer readable medium, a computer program product, a graphical user interface, including a web portal, or a data structure tangibly fixed in a computer readable memory. Several embodiments of the invention are discussed below.

FIG. 6 depicts an exemplary embodiment of an improved dynamic braking system performance curve compared to the prior art performance curve. Typically I_{f} is a variable current whereas Iₐ is a constant current. By switching between an I_{f} control technique and an Iₐ control technique where both I_{f} and Iₐ are varied, a higher level of dynamic braking effort 21 is possible at lower speeds without using extended range contactors. By using a standard distributed braking system with a processor having an algorithm for functioning within the controller for controlling switching between the I_{f} control technique and the Iₐ control technique an increased collective field current I_{f} Limit 2 results. The combined field I_{f} current and Iₐ current curve form a plateau 22. As a vehicle's speed increases, Iₐ decreases as speed increases as represented by graph 23. More specifically, rather than selecting between the lower of Iₐ limit and I_{f} limit, the plateau 22 is created by allowing I_{f} to exceed its previous limit while concurrently reducing Iₐ to maintain a constant developed effort. Therefore, for vehicles that only have standard dynamic braking systems, an improved performance of the dynamic braking system can be realized by allowing a middle range between the constant I_{f} and constant Iₐ zones, where both current are concurrently varied to trace out a constant effort.

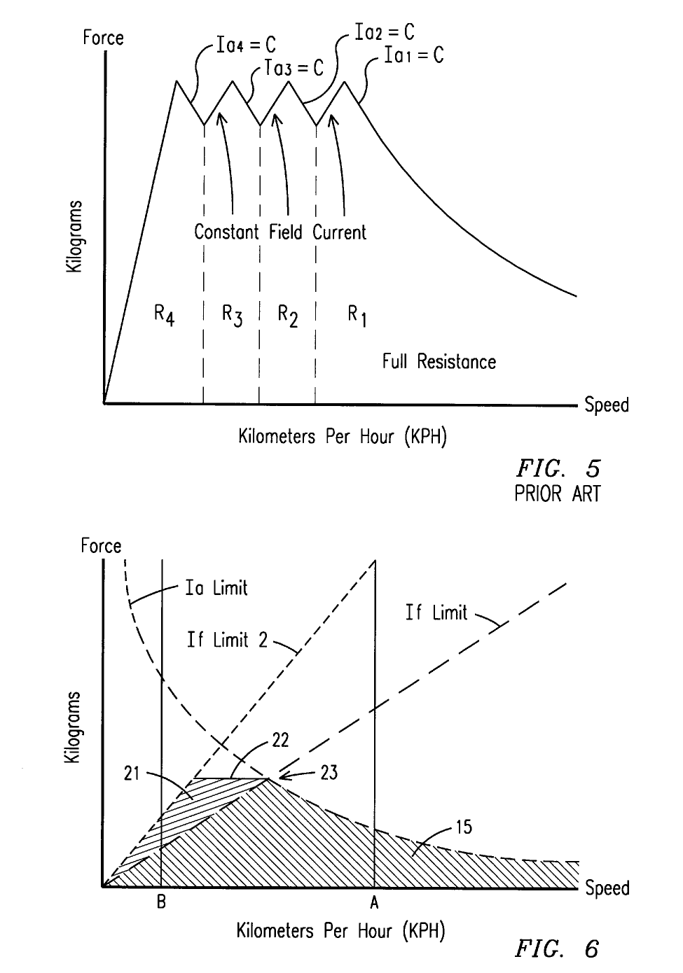

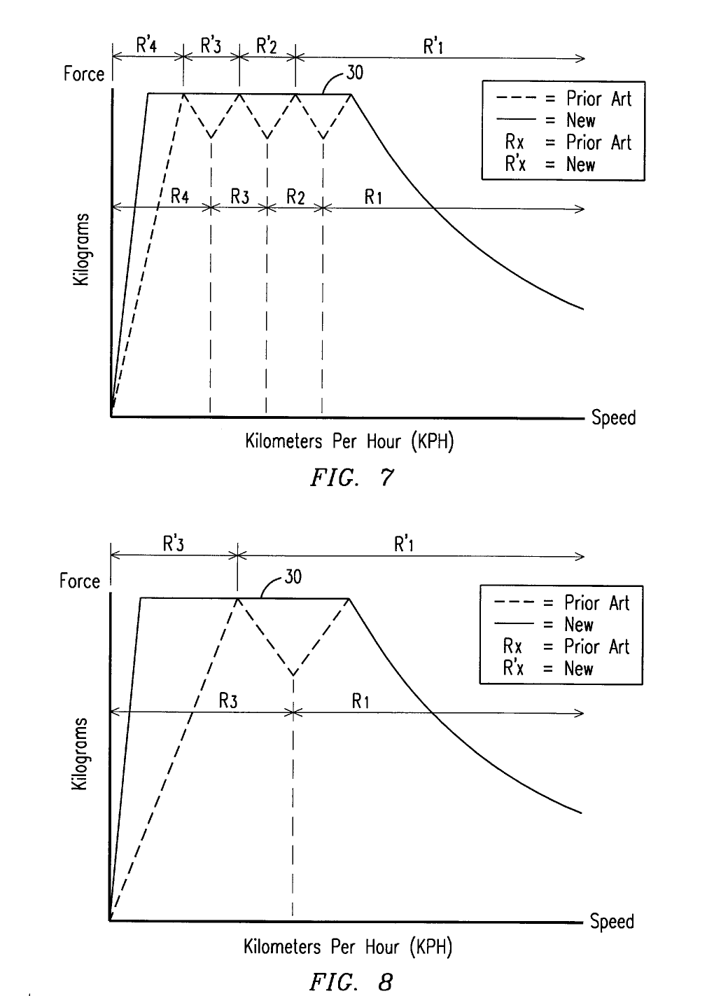

FIG. 7 depicts an exemplary embodiment of a flat plateau characteristic curve of an extended range dynamic braking system with four resistance values using the switching technique of an exemplary embodiment of the invention. The dotted graph illustrates the prior art graph with resistance change points, R₁, R₂, R₃, R₄, such as illustrated in FIG. 5. The solid line graph illustrates the plat plateau characteristics realized by implementing the system, method, and/or computer software code disclosed herein. The resistance change points, R₁′, R₂′, R₃′, and R₄′ shift to the left on the graphing scale, or occur at lower speeds. As illustrated, by switching between I_{f} control techniques and Iₐ control techniques results in each combined current peak extending to the left to create a smoother or flat braking effort current plateau 30. Therefore, for vehicles that have extended dynamic braking systems, an improved performance of the extended dynamic braking system is realized.

Depending on the vehicle requirements, by using an embodiment of the invention, if the plateaus developed by the concurrent variation of I_{f} and Iₐ are broad enough, it may be possible to eliminate some of the contactors 20 that are part of the braking system and still maintain the plateau shown. This is possible because while it was previously necessary to change resistance to increase the developed effort at low speed, it is now possible to increase I_{f} without exceeding the desired peak braking effort.

FIG. 8 depicts an exemplary embodiment of a flat braking effort current plateau characteristic curve of an extended range dynamic braking system with two resistance values. The dotted graph illustrates a prior art graph with resistance change points, R₁ and R₃. Thus, by having fewer resistors, this extended dynamic braking system has fewer components than the standard extended dynamic braking system. Using the switching technique may result in elimination of approximately two thirds of the contactors which results in cost and reliability improvements while also providing for the flat plateau 36. The solid line graph illustrates the plat plateau characteristics realized by implementing the system, method, and/or computer software code disclosed herein. Therefore, the resistance change points, R₁′ and R₃′ shift to the left on the graphing scale, or occur at lower speeds. Such systems would use less physical space than the typical prior art extended dynamic braking system.

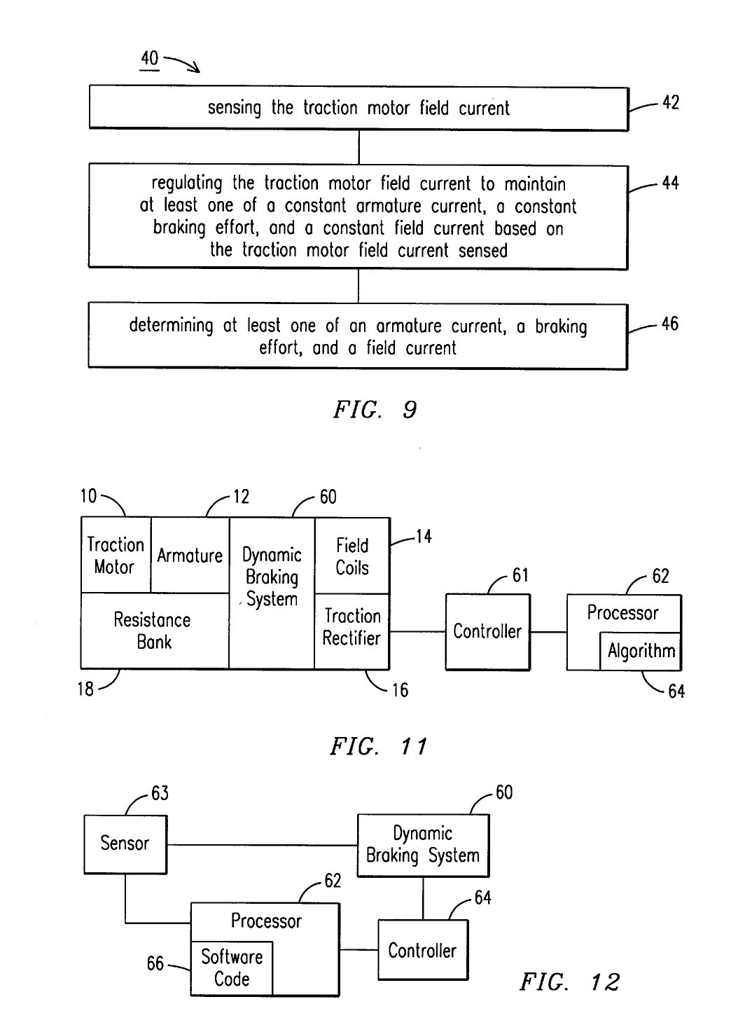

FIG. 9 depicts an exemplary flow chart for controlling a performance of a dynamic braking system to maintain a dynamic braking tractive effort current plateau and/or improve the dynamic braking tractive effort current plateau. As illustrated, the flow chart 40 discloses sensing the traction motor field current, at 42. The flow chart 40 also discloses regulating the traction motor field current to maintain at least one of a constant armature current, a constant braking effort, and a constant field current based on the traction motor field current sensed, at 44. Determining an armature current, a braking effort, and/or a field current, at 46, is also disclosed. In an exemplary embodiment the armature current and field current are measured whereas the braking effort is calculated based on the armature current and/or the traction motor field current.

In one exemplary embodiment, a pattern for regulating may be based on a pre-determined regulation pattern. In yet another exemplary embodiment, the pattern for regulating is based on real-time data obtained regarding the armature current, the braking effort, and/or the field current. As disclosed above, this flow chart 40 may be implemented using a computer software code where the computer software code may reside on a computer readable media.

FIG. 10 depicts another exemplary flow chart of a method for controlling a performance of a dynamic braking system to maintain a dynamic braking tractive effort current plateau and/or improve the dynamic braking tractive effort current plateau. This flowchart 50 discloses measuring an armature current and/or a traction motor field current, at 52. The method further discloses regulating a traction motor field current to maintain a constant armature current, at 53, regulating the traction motor field current to maintain a constant braking effort, at 54, and maintaining a constant field current, at 55. The method further discloses alternating between regulating the traction motor field current to maintain the constant armature current, regulating the traction motor field current to maintain the constant braking effort, and/or maintaining the constant field current when a decrease in armature current is detected, at 56. A determination as to whether to maintain the constant armature current, the constant braking effort, and/or the constant field current based on the traction motor field current measured is disclosed, at 57. The flowchart 50 further discloses switching between maintaining the constant armature current, the constant braking effort, and/or the constant field current based on a pre-programmed schedule, at 58. The constant braking effort is determined based on a calculation that includes the measured armature current and/or the measured traction motor field current, at 59. As disclosed above, this flow chart 50 may be implemented using a computer software code where the computer software code may reside on a computer readable media.

FIG. 11 depicts an exemplary illustration of a block diagram for controlling a performance of a dynamic braking system to maintain a dynamic braking tractive effort current plateau and/or improve the dynamic braking tractive effort current plateau. A dynamic braking system 60 is disclosed being a system on a locomotive 61. The dynamic braking system 50 may include a traction motor 10 and a resistance bank 18 proximate the traction motor 10, such as connected through an armature 12. A traction rectifier 16 and field coils 14 are also included. As discussed above, the traction motor 10 has armatures 12. A processor 62 is in communication with the dynamic braking system 60. The processor 62 may be in communication through a controller 61. The controller 61 receives commands from the processor 62 and then performs the function within the dynamic braking system 60. The controller 61 may also be operated manually, such as through a lever by an operator. The processor 62 may be located a plurality of locations on the locomotive. An algorithm 64 operates within the processor 62 to control the switching between limiting the traction motor field current, I_{f}, and limiting the armature current, Iₐ. The function performed may be based on a pre-programmed schedule. In another embodiment the function is performed based on receiving real-time data, such as the traction motor field current.

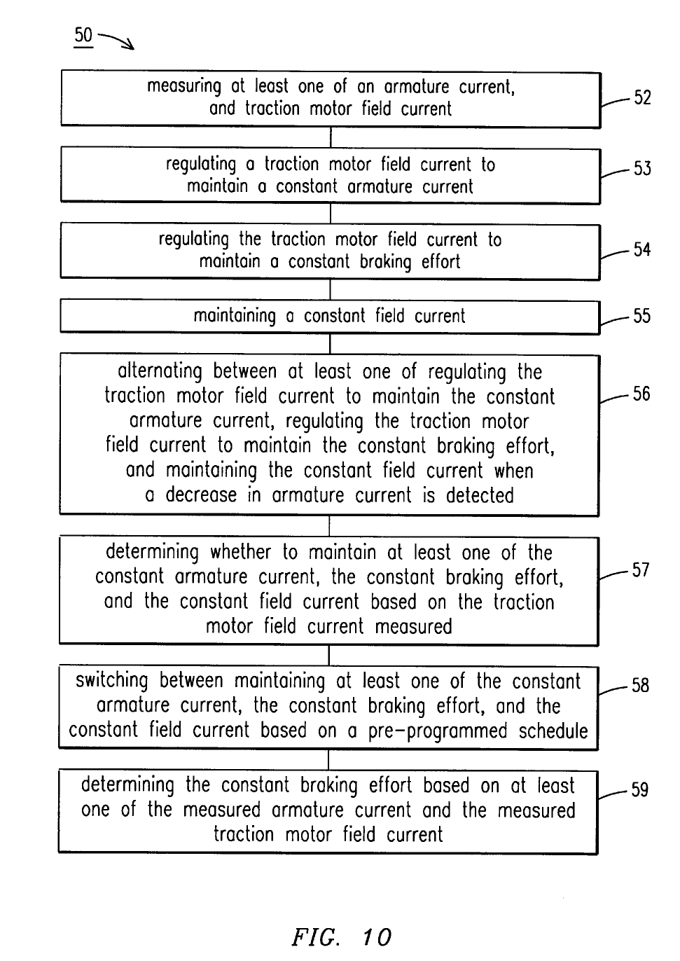

FIG. 12 depicts an exemplary illustration of a block diagram of elements for controlling a performance of a dynamic braking system (or apparatus) to maintain a dynamic braking tractive effort current plateau and/or improve the dynamic braking tractive effort current plateau. At least one sensor 63 is disclosed for measuring an armature current, a braking effort, and/or a traction motor field current. Though at least one sensor 63 is disclosed, those skilled in the art will readily recognize that at least one individual sensor 63 may be used to measure each of the armature current, the braking effort, and/or the traction motor field current. Therefore the term at least one sensor should not be viewed as limiting the term sensor.

A processor 62 is disclosed that is configured to receive a measurement from the at least one sensor 63 and to determine a braking control. The measurement is determined from a dynamic braking system 60. The braking control is the methodology for to maintain a dynamic braking tractive effort current plateau and/or to improve the dynamic braking tractive effort current plateau. A controller 64 is configured to regulate a traction motor field current, limit an armature current, and/or limit the dynamic braking tractive effort based on the braking control from the processor.

A computer software code 66 is disclosed, operable within the processor. The computer software code 66 is configured to regulate the traction motor field current, limit an armature current, and/or limit the dynamic braking tractive effort. The computer software code 66 may originate the braking control. Furthermore measurements from the at least one sensor 63 may be provided directly to the computer software code 66. Similarly, the braking control may be provided directly from the computer software code 66 to the controller 64.

Those skilled in the art will recognize that with respects to limiting the armature current this may be accomplished by limiting the armature current control, or control technique as disclosed above. Likewise, limiting the traction motor field current may be accomplished by limited the armature current control, or control technique as disclosed above. Therefore, with respect to a dynamic braking system the terms “limiting the armature current” and “limiting the traction motor field current” should not be afforded the scope of how limiting these currents may be accomplished.

The controller 64 then controls the operation of the dynamic braking system (or apparatus) 60 resulting in maintaining the dynamic braking tractive effort current plateau and/or improving the dynamic braking tractive effort current plateau. As illustrated, the system may operate in a closed-loop system. In another exemplary embodiment, human interaction may be used, such as where braking information is relayed to an on-board operator who then determines whether to apply the dynamic braking tractive effort disclosed.

While the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for controlling a performance of a dynamic braking system to at least one of maintain a dynamic braking tractive effort current plateau and improve the dynamic braking tractive effort current plateau, the method comprising:
sensing the traction motor field current; and
regulating the traction motor field current to maintain at least one of a constant armature current, a constant braking effort, and a constant field current based on the traction motor field current sensed.

2. The method according to claim 1, wherein regulating the traction motor field current further comprises determining a pattern for regulating based on a pre-determined regulation pattern.

3. The method according to claim 1, wherein regulating the traction motor field current further comprises determining a pattern for regulating based on real-time data obtained from at least one of an armature current, a braking effort, and a field current.

4. The method according to claim 1, further comprises determining at least one of an armature current, a braking effort, and a field current.

5. The method according to claim 1, wherein the armature current and the field current are measured and the braking effort is calculated based on at least one of the armature current and the field current.

6. The method according to claim 1, wherein regulating the traction motor field current further comprises at least one of limiting an armature current and limiting a dynamic braking tractive effort.

7. A system for at least one of maintaining a dynamic braking tractive effort current plateau and improving the dynamic braking tractive effort current plateau of a dynamic braking apparatus, the system comprising:
at least one sensor to measure at least one of an armature current and a traction motor field current;
a processor configured to receive a measurement from the at least one sensor and to determine a braking control; and
a controller configured to at least one of regulate a traction motor field current, limit an armature current, and limit a dynamic braking tractive effort based on the braking control determined by the processor.

8. The system according to claim 7, further comprises a computer software code operable within the processor and configured to at least one of regulate the traction motor field current control, limit the armature current control, and limit the dynamic braking tractive effort.

9. The system according to claim 7, wherein the controller is configured to at least one of regulate the traction motor field current, limit an armature current, and limit the dynamic braking tractive effort based on a pre-programmed schedule.

10. The system according to claim 7, wherein the controller is configured to at least one of regulate a traction motor field current, limit an armature current, and limit the dynamic braking tractive effort based on a real-time measurement provided by the at least one sensor.

11. The system according to claim 10, wherein the real-time measurement comprises a traction motor field current provided to the controller.

12. A computer software code, storable on a computer media and operable in a processor, for controlling a performance of a dynamic braking system to at least one of maintain a dynamic braking tractive effort current plateau and improve the dynamic braking tractive effort current plateau, the computer software code comprising:
a computer software module for gathering a measurement from a traction motor field current;
a computer software module for regulating the traction motor field current to maintain at least one of a constant armature current, a constant braking effort, and a constant field current based on the traction motor field current sensed.

13. The computer software code according to claim 12, wherein the computer software module for regulating the traction motor field current further comprises a computer software module for determining a pattern for regulating based on a pre-determined regulation pattern.

14. The computer software code according to claim 12, wherein the computer software module for regulating the traction motor field current further comprises a computer software module for determining a pattern for regulating based on real-time data obtained about at least one of an armature current, a braking effort, and a field current.

15. The computer software code according to claim 12, further comprises a computer software module for determining at least one of an armature current, a braking effort, and a field current.

16. The computer software code according to claim 12, wherein the computer software module for regulating the traction motor field current further comprises at least one of a computer software module for limiting an armature current and a computer software module for limiting a dynamic tractive effort.

17. A method for controlling a performance of a dynamic braking system to at least one of maintain a dynamic braking tractive effort current plateau and improve the dynamic braking tractive effort current plateau, the method comprising:
measuring at least one of an armature current and traction motor field current;
regulating a traction motor field current to maintain a constant armature current;
regulating the traction motor field current to maintain a constant braking effort;
maintaining a constant field current; and
alternating between at least one of regulating the traction motor field current to maintain the constant armature current, regulating the traction motor field current to maintain the constant braking effort, and maintaining a constant field current when a decrease in armature current is detected.

18. The method according to claim 17, further comprises determining whether to maintain at least one of the constant armature current, the constant braking effort, and the constant field current based on the traction motor field current measured.

19. The method according to claim 17, further comprises switching between maintaining at least one of the constant armature current, the constant braking effort, and the constant field current based on a pre-programmed schedule.

20. The method according to claim 17, further comprises determining the constant braking effort based on at least one of the measured armature current and the measured traction motor field current.
